(19) United States
(12) Patent Application Publication
(10) Pub. No.: US 2006/0154037 A1
(43) Pub. Date: Jul. 13, 2006

(54) Polyimide-copper composite laminate

(75) Inventors: Hiroto Shimokawa, Yamaguchi (JP); Kohji Narui, Yamaguchi (JP); Toshinori Hosoma, Yamaguchi (JP); Toshihiko Anno, Yamaguchi (JP)

Correspondence Address: NIXON PEABODY, LLP, 401 9TH STREET, NW, SUITE 900, WASHINGTON, DC, 20004-2128, US

(73) Assignee: UBE INDUSTRIES, LTD., Ube-shi (JP)

(21) Appl. No.: 11/052,829

(22) Filed: Feb. 9, 2005

(30) Foreign Application Priority Data
Jan. 7, 2005 (JP) 2005-003066

(51) Int. Cl. B32B 15/08; B32B 27/06

(52) U.S. Cl. 428/216; 428/458; 428/473.5

(57) ABSTRACT

A polyimide-copper composite laminate is composed of a metallic carrier having a thickness of 10-35 μm and a thin copper film having a thickness of 1-8 μm, and an intervening heat-resistant layer and an aromatic polyimide film directly fixed to the thin copper film without adhesive.

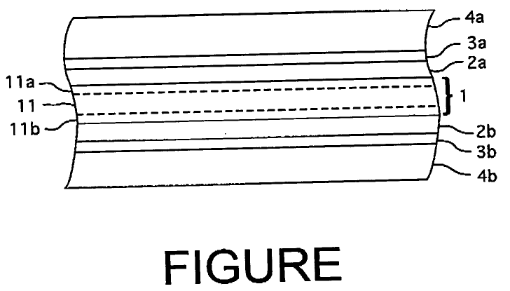

### FIELD OF THE INVENTION

The present invention relates to a polyimide-copper composite laminate (copper-clad laminate) comprising an aromatic polyimide film (or layer) and a thin copper film attached to the polyimide film at a high peel strength.

### BACKGROUND OF THE INVENTION

An aromatic polyimide film has excellent characteristics in its heat resistance, mechanical strength, electric properties, resistance to alkali and acid, and flame resistance, and hence is widely utilized, for instance, to produce a copper-clad laminate for manufacturing a flexible printable circuit board and a tape-automated bonding board.

The conventional copper-clad laminate comprises a copper film having a thickness of approximately 35 μm and an aromatic polyimide film attached to the copper film. The polyimide film is attached to the copper film via an adhesive of epoxy resin or thermoplastic polyimide resin. Otherwise, the polyimide film is in-situ formed on a copper film using a polyamic acid solution.

Recently, there arises a need of forming an electric circuit of a fine pattern. Therefore, a request for a polyimide-copper composite laminate having a copper film of several micron meters increases.

Japanese Patent Provisional Publication 2002-316386 describes a copper-clad laminate comprising a copper film having a thickness of 1 to 8 μm, an adhesive layer comprising a thermoplastic polyimide resin, and a heat-resistant film. It is described that the copper-clad laminate is manufactured by the steps of: forming an adhesive layer on a heat-resistant film; placing a carrier-containing copper film on the adhesive layer; heating the resulting composite laminate under pressure to fix the carrier-containing copper film to the adhesive layer; and separating the carrier.

### SUMMARY OF THE INVENTION

It is an object of the present invention to provide a polyimide-copper composite laminate comprising a carrier-containing thin copper film and an aromatic polyimide which is favorably employable for forming an electric circuit of a fine pattern.

The present invention resides in a polyimide-copper composite laminate comprising a metallic carrier having a thickness in the range of 10 to 35 μm and a thin copper film having a thickness in the range of 1 to 8 μm, and an intervening heat-resistant layer placed between the metallic carrier and the thin copper film and an aromatic polyimide film directly fixed to the thin copper film without adhesive.

The polyimide-copper composite laminate is preferably provided in the form of a continuous web.

The intervening heat-resistant layer is preferably made of ceramic material or metal.

It is preferred that the aromatic polyimide film is fixed to the copper film at a peel strength of 0.7 N/mm or higher and the copper film is fixed to the metallic carrier at a peel strength of not higher than 0.2 N/mm, more preferably in the range of 0.001 to 0.2 N/mm (most preferably 0.01 to 0.1 N/mm).

It is also preferred that the peel strength between the aromatic polyimide film and the copper film shows no decrease after heat treatment at 150° C. for 168 hours.

### BRIEF DESCRIPTION OF DRAWINGS

FIGURE is a schematic view of a structure of a polyimide-copper composite laminate of the invention.

### DETAILED DESCRIPTION OF THE INVENTION

The polyimide-copper composite laminate of the invention typically has a structure illustrated in the attached FIGURE. In FIGURE, the polyimide-copper composite laminate is composed of a center polyimide film 1, thin copper films 2a, 2b, heat-resistant intervening layers 3a, 3b, and metallic carrier films 4a, 4b, The polyimide film can be formed of a heat-resistant center polyimide layer 11 and two thermoplastic surface polyimide layers 11a, 11b.

The polyimide-copper composite laminate of the invention can comprise the polyimide film 1 and one set of the thin copper film 2a, the intervening layer 3a, and the metallic carrier film 4a.

The polyimide-copper composite laminate preferably has pin-holes in numbers of at most 350/1 m².

The peel strength between the aromatic polyimide film and the copper film preferably shows no decrease after heat treatment at 150° C. for 168 hours.

The metallic carrier film generally has a thickness in the range of 10 to 35 μm, preferably 10 to 22 μm, more preferably 15 to 22 μm. The carrier film preferably is made of copper. The thin copper film generally has a thickness in the range of 1 to 8 μm, preferably 1 to 3 μm. The heat-resistant intervening layer generally has a thickness in the range of 10 to 200 nm and can be made of metal (such as metal alloy) or ceramic material.

A set of the metallic carrier film, the heat-resistant intervening layer, and the thin copper film is commercially supplied in the combined form. This is generally called a carrier-containing copper film. Examples of the commercially supplied carrier-containing copper films include YSNAP-3B (copper film/copper carrier=3 μm/18 μm) available from Nippon Denkai, Ltd., YSNAP-1B (copper film/copper carrier=1 μm/18 μm) available from Nippon Denkai, Ltd., XTF (copper film/copper carrier=5 μm/35 μm or 3 μm/35 μm) available from Olin Co., Ltd., and F-CP (copper film/copper carrier=5 m/35 μm or 3 μm/35 μm) manufactured by Furukawa Circuit Foil Co., Ltd., available from Furukawa Electric Co., Ltd.).

The aromatic polyimide film preferably is a multi-layer film comprising two thermoplastic aromatic polyimide layers and an intervening heat-resistant aromatic polyimide layer showing no glass transition temperature below 300° C.

The multi-layer polyimide film is preferably prepared by an extrusion process which is performed by the following method.

A polyamic acid solution containing a polyamic acid for the heat resistant aromatic polyimide and a polyamic acid solution containing a polyamic acid having a bendable bonding in the main chain are separately extruded, and subsequently placing one on another to form a multi-layered solution product. Each of the polyamic acid solutions preferably has a viscosity of 500 to 5,000 poises. The multi-layered solution product is dried at a temperature of 80 to 200° C., and then cured at a temperature of not lower than 300° C., preferably 300 to 550° C. Thus, the desired multi-layer polyimide film is prepared.

The multi-layer polyimide film preferably has a thickness in the range of 10 to 75 μm, more preferably 10 to 50 μm. The surface layer (i.e., thermoplastic polyimide layer) preferably has a thickness in the range of 1 to 8 μm, more preferably 1 to 5 μm. The center layer (i.e., heat-resistant polyimide layer) preferably has a thickness in the range of 8 to 75 μm, more preferably 8 to 48 μm, particularly preferably 10 to 38 μm.

The multi-layer polyimide film can be prepared on a copper film by a coating process.

The heat resistant aromatic polyimide preferably has no glass transition temperature below 300° C.

The heat resistant aromatic polyimide is preferably prepared from 3,3′,4,4′-biphenyltetracarboxylic dianhydride (s-BPDA) and p-phenylenediamine (PPD). A portion (not more than 50 mol. %) of s-BPDA can be replaced with pyromellitic dianhydride (PMDA), and a portion (not more than 15 mol. %) of PPD can be replaced with 4,4′-diaminodiphenyl ether (DADE). Alternatively, the heat resistant aromatic polyimide can be prepared from pyromellitic dianhydride (PMDA) and p-phenylenediamine (PPD). A portion (10 to 90 mol. %) of PPD can be replaced with DADE. Otherwise, the heat resistant aromatic polyimide can be prepared from an aromatic tetracarboxylic compound mixture comprising 20-90 mol. % of 3,3′,4,4′-benzophenonetetracarboxylic dianhydride (BTDA) and 10-80 mol. % of pyromellitic dianhydride (PMDA), and an aromatic diamine compound mixture comprising 30-90 mol % of p-phenylenediamine (PPD) and 10-70 mol. % of 4,4′-diaminodiphenyl ether (DADE).

The heat resistant aromatic polyimide can be prepared by any of random polymerization, block polymerization and polymer blend. The polymer blend can be prepared from a mixture of two or more polyamic acid solutions.

In the preparation of the heat resistant aromatic polyimide, a phosphorus stabilizer such as triphenyl phosphite or triphenyl phosphate can be added to the polyamic acid so as to obviate gel formation. In the dope solution (i.e., polyamic acid solution), a basic organic compound such as imidazole, 2-imidazole, 1,2-dimethylimidazole, or 2-phenylimidazole can be placed in an amount of 0.01 to 20 wt. % (on the basis of the aunt of polyamic acid), specifically 0.5 to 10 wt. %, so as to accelerate the imidation reaction.

For the preparation of the polyimide for the surface layer, 0.01 to 10 wt. % of inorganic or organic fine particles (such as polyimide fine particles) can be added to the dope solution.

The heat resistant aromatic polyimide layer preferably has a linear expansion coefficient (at 50 to 200° C.) in the range of 10×10⁻⁶ cm/cm/° C. to 25×10⁻⁶ cm/cm/° C. (all of MD, TD and their average).

The thermoplastic aromatic polyimide preferably contains an aromatic diamine unit having at least two benzene rings combined via —CH₂— or —CO— and/or an asymmetric aromatic tetracarboxylic acid unit in its molecular structure. The asymmetric aromatic tetracarboxylic acid unit can be 2,3,3′,4′-biphenyltetracarboxylic acid unit.

The thermoplastic aromatic polyimide can be prepared from one of the following combinations:

(1) 1,3-bis(4-aminophenoxybenzene) (TPER) and 2,3,3′,4′-biphenyltetracarboxylic dianhydride (a-BPDA);

(2) 1,3-bis(4-aminophenoxy)-2,2-dimethylpropane (DANPG) and 4,4′-oxydiphthalic dianhydride (ODPA);

(3) 4,4′-oxydiphthalic dianhydride (ODPA), pyromellitic dianhydride (PMDA), and 1,3-bis(4-aminophenoxybenzene);

(4) 1,3-bis(3-aminophenoxy)benzene and 3,3′,4,4′-benzophenonetetracarboxylic dianhydride;

(5) 3,3′-diaminobenzophenone, 1,3-bis(3-aminophenoxy)benzene, and 3,3′,4,4′-benzophenonetetracarboxylic dianhydride; and

(6) 2,3,3′,4′-biphenyltetracarboxylic dianhydride, 3,3′,4,4′-biphenyltetracarboxylic dianhydride (s-BPD), 1,3-bis(4-aminophenoxybenzene) and 4,4′-diaminodiphenyl ether (DADE).

The polyimide-copper composite laminate of the invention can be manufactured, for instance, by placing a pair of thin copper films each attached to a carrier and a three-layer polyimide film having a thermoplastic surface polyimide layer on either side in layers of copper film/polyimide film/copper film and introducing the resulting laminate into a double belt press. The laminate is preferably pre-heated to 150-250° C. just before it is introduced into the double belt press. The laminate is then heated to an elevated temperature under pressure and cooled to give the polyimide-capper composite laminate.

In the double belt press, the laminate is heated under pressure to a temperature of lower than 400° C. but higher than the glass transition temperature of the thermoplastic polyimide by 20° C. or more (particularly, a temperature of lower than 400° C. but higher than the glass transition temperature of the thermoplastic polyimide by 30° C. or more) and subsequently cooled in a cooling area to a temperature of lower than the glass transition temperature of the thermoplastic polyimide by 20° C. or more, specifically by 30° C. or more, to give the polyimide-copper composite laminate.

If a polyimide-copper composite laminate composed of the three-layer polyimide film and one carrier-containing copper film is desired, a releasable, highly heat resistant protective film such as a highly heat resistant film having Rz of less than 2 μm (e.g., Upilex S, a polyimide film available from Ube Industries, Ltd., a fluororesin film, electrolytic copper film, rolled copper film) can be placed on the thermoplastic polyimide layer before the polyimide-copper composite laminate is wound to give a roll.

Thus, the polyimide-copper composite laminate of the invention having numbers of at most 350 pinholes per one square mater (1 m²) can be manufactured. Moreover, the polyimide-copper composite laminate shows no foaming after it is subjected to 300° C. for 0.1 min. or longer in the heat treatment in the course of the laminating procedure.

The polyimide-copper composite laminate of the invention is generally manufactured in the form of a continuous web and can be stored in the form of a roll. When it is employed for manufacturing electronic parts, it can be subjected to a procedure for removing curling. The polyimide-copper composite laminate of the invention can be employed, for instance, as a substrate for manufacturing FPC, multi-layer FPC or flex-rigid substrate.

If desired, the carrier film can be separated from the thin copper film of the composite laminate, and the exposed thin copper film can be combined with another thin copper film via a heat resistant polyimide adhesive such as a thermoplastic polyimide. Thus, a multi-layer substrate having 2 to 10 thin copper films can be manufactured.

The polyimide-copper composite laminate of the invention can be subjected to a known etching procedure after the carrier film is removed, to give a circuit board. The etching can be carried out at roan temperature using a known etching solution such as an aqueous ferric chloride solution.

The polyimide-copper composite laminate of the invention can be dipped for approx. 10 seconds in a soldering bath heated to 280° C., after the carrier film is removed.

The present invention is further described by the following examples.

In the following examples, the physical and chemical characteristics were determined by the methods described below.

Linear expansion coefficient: measured at temperatures of 50 to 200° C., by increasing the temperature at 5° C./min. The coefficient is expressed in term of cm/cm/° C. (average of the data measured in TD and MD).

Glass transition temperature (Tg): determined by viscoelastic measurement.

Peel strength I (between the polyimide film and the thin copper film): The carrier film is removed, and plated on the thin copper film to give a plated layer of 9 μm thick to give a specimen having a 10 mm width. The specimen is subjected to 90° peel test defined in JIS C6471 (at a rate of 50 mm/min.). Another specimen is heated to 150° C. for 168 hours and then subjected to the same peel test.

Peel strength II (between the carrier film and the thin copper film): The composite laminate is processed to give a specimen having width of 10 mm. The specimen is subjected to 904 peel test described above.

Appearance: Deformation caused by foaming is visually observed. A composite laminate having any foaming cannot be used as a commercial product. AA: no foaming, BB: foaming is observed on whole surface.

Pinholes: The carrier film is separated from the composite laminate to give a sample which is then exposed to light in a dark room to detect pinholes using light transmission. The detected pinholes are then microscopically observed to check their sizes. The minimum size of the detectable pinhole is 5 μm. Total three samples are subjected to the pinhole detection. The maximum numbers (Max.), the minimum numbers (Min.), and their average (Ave.) are counted.

Total Judgement: AA: good, BB: bad

[Synthesis of Dope Solution 1 for Heat Resistant Polyimide Layer]

In a reaction vessel equipped with a stirrer and a nitrogen gas inlet were placed N-methyl-2-pyrrolidone and a monomer mixture of p-phenylenediamine and 3,3′,4,4′-biphenyltetracarboxylic dianhydride (1000:998, molar ratio), to give a solution having a monomer concentration of 18 wt. %. Thereafter, the solution was stirred at 50° C. for 3 hours to give a polyamic acid solution (dope solution 1). The polyamic acid solution was a brown-colored viscous liquid having a solution viscosity of approx. 1,500 poises (at 25° C.).

[Synthesis of Dope Solution 2 for Thermoplastic Polyimide Layer]

In a reaction vessel equipped with a stirrer and a nitrogen gas inlet were placed N-methyl-2-pyrrolidone and a monomer mixture of 2,3,3′,4′-biphenyltetracarboxylic dianhydride, 3,3′,4,4′-biphenyltetracarboxylic dianhydride, 1,3-bis(4-aminophenoxy)benzene and 4,4′-diaminodiphenyl ether (20:80:50:50, molar ratio), to give a solution having a monomer concentration of 22 wt. %. To the solution were then added 0.1 wt. % (based on the total monomer content) of triphenyl phosphate and 0.5 wt. % of polyimide particles (mean particle size: 0.3 μm, prepared from pyromellitic dianhydride and p-phenylenediamine). Thereafter, the solution was stirred at 25° C. for 1 hour to give a polyamic acid solution (dope solution 2). The polyamic acid solution was a viscous liquid having a solution viscosity of approx. 2,000 poises (at 25° C.).

[Synthesis of Dope Solution 3 for Thermoplastic Polyimide Layer]

In a reaction vessel equipped with a stirrer and a nitrogen gas inlet were placed N-methyl-2-pyrrolidone and a monomer mixture of 4,4′-di diphenyl ether and 3,3′,4,4′-biphenyltetracarboxylic dianhydride, to give a solution having a monomer concentration of 22 wt. %. To the solution were then added 0.1 wt. % (based on the total monomer content) of triphenyl phosphate and 0.5 wt.-% of colloidal silica (mean particle size: 0.08 μm). Thereafter, the solution was stirred at 25° C. for 1 hour to give a polyamic acid solution (dope solution 3). The polyamic acid solution was a viscous liquid having a solution viscosity of approx. 2,000 poises (at 25° C.).

[Preparation of Three-Layer Polyimide Film a1-a2]

The dope solution 1 and dope solution 2 were introduced a molding die for three layer extrusion (manifold type die) and spread on a metallic support to give a three layer solution film. The solution film was continuously heated to 140° C. to give a solid film. The solid film was separated from the support and heated in a heating furnace by gradually increasing the temperature from 200° C. to 320° C. so as to remove the solvent and effect imidation. Thus, three-layer polyimide films a1 and a2 were prepared.

1) Three-layer polyimide film a1
layer structure: 4 μm/17 μm/4 μm (total 25 μm)
thermoplastic surface layer: Tg=261° C.
linear expansion coefficient: 19×10⁻⁶ cm/cm/° C.
volume resistance: 5×10¹⁵ Ω·cm

2) Three-layer polyimide film a2
layer structure: 5 μm/28 μm/5 μm (total 38 μm)
thermoplastic surface layer: Tg=265° C.
linear expansion coefficient: 20×10⁻⁶ cm/cm/° C.
volume resistance: 6×10¹⁵ Ω·cm
   [Preparation of Three-Layer Polyimide Films b1-b3]

The dope solution 1 and dope solution 2 were introduced a molding die for three layer extrusion (manifold type die) and spread on a metallic support to give a three layer solution film. The solution film was continuously heated to 140° C. to give a solid film. The solid film was separated from the support and heated in a heating furnace by gradually increasing the temperature from 200° C. to 320° C. so as to remove the solvent and effect imidation. Thus, three-layer polyimide films b1 to b3 were prepared.

3) Three-layer polyimide film b1
layer structure: 4 μm/17 μm/4 μm (total 25 μm)
thermoplastic surface layer: Tg=261° C.
linear expansion coefficient: 19×10⁻⁶ cm/cm/° C.
volume resistance: 4×10¹⁶ Ω·cm

4) Three-layer polyimide film b2
layer structure: 8 μm/34 μm/8 μm (total 50 μm)
thermoplastic surface layer: Tg=261° C.
linear expansion coefficient: 19×10⁻⁶ cm/cm/° C.
volume resistance: 4×10¹⁶ Ω·cm

5) Three-layer polyimide film b3
layer structure: 2 μm/31 μm/2 μm (total 15 μm)
thermoplastic surface layer: Tg=261° C.
linear expansion coefficient: 18×10⁻⁶ cm/cm/° C.
volume resistance: 3×10¹⁶ Ω·cm
   [Preparation of Three-Layer Polyimide Film c1]

The dope solution 1 and dope solution 3 were introduced a molding die for three layer extrusion (manifold type die) and spread on a metallic support to give a three layer solution film. The solution film was continuously heated to 140° C. to give a solid film. The solid film was separated from the support and heated in a heating furnace by gradually increasing the temperature from 200° C. to 320° C. so as to remove the solvent and effect imidation. Thus, a three-layer polyimide film c1 was prepared.

6) Three-layer polyimide film c1
layer structure; 3 μm/32 μm/3 μm (total 38 μm)
thermoplastic surface layer: Tg=275° C.
linear expansion coefficient: 17×10⁻⁶ cm/cm/° C.
volume resistance: 4×10¹⁶ Ω·cm
   [Thin Copper Film Having Thick Copper Carrier Film]

The following carrier-containing thin copper films are employed:
A1: XTF (5 μm/35 μm, Olin Co., Ltd.)
A2: XTF (3 μm/35 μm, Olin Co., Ltd.)
A3: F-CP (5 μm/35 μm, Furukawa Electric Co., Ltd.)
A4: F-CP (3 μm/35 μm, Furukawa Electric Co., Ltd.)
B1: YSNAP-3B (3 μm/18 μm, intervening layer: ceramics, Nippon Denkai Co., Ltd.)
B2: YSNAP-1B (1 μm/18 μm, intervening layer: ceramics, Nippon Denkai Co., Ltd.)
C1: MT35S-H (5 μm/35 μm, intervening layer: organic adhesive, Mitsui Metal Industries)

### EXAMPLE 1

One three-layer polyimide film a1 and two carrier-containing thin copper films A1 were continuously supplied into a double belt press and pre-heated. After pre-heating, the films were continuously heated in a heating zone and cooled in a cooling zone under the following conditions:

Highest heating temperature: 330° C. (setting)

Lowest cooling temperature: 117° C.

Pressure: 40 kg/cm²

Pressing Period: 2 min.

to give a roll of a polyimide-copper composite laminate having a width of approx. 530 mm.

The obtained polyimide-copper composite laminate had the following characteristics:

Appearance: AA

Peel strength I: 0.9 N/mm

Peel strength II: 0.00 N/mm (<measurement limit)

Total judgement: AA

### EXAMPLE 2

The procedures of Example 1 were repeated except for employing the carrier-containing thin copper films A2 to give a roll of a polyimide-copper composite laminate having a width of approx. 530 mm.

The obtained polyimide-copper composite laminate had the following characteristics:

Appearance: AA

Peel strength I: 1.0 N/mm

Peel strength II: 0.00 N/mm (<measurement limit)

Total judgement: AA

### EXAMPLE 3

The procedures of Example 1 were repeated except for employing the three-layer polyimide film a2 to give a roll of a polyimide-copper composite laminate having a width of approx. 530 mm.

The obtained polyimide-copper composite laminate had the following characteristics:

Appearance: AA

Peel strength I: 0.9 N/mm

Peel strength IT: 0.00 N/mm (<measurement limit)

Total judgement: AA

### EXAMPLE 4

The procedures of Example 1 were repeated except for employing the carrier-containing thin copper films A3 to give a roll of a polyimide-copper composite laminate having a width of approx. 530 mm.

The obtained polyimide-copper composite laminate had the following characteristics:

Appearance; AA

Peel strength I: 0.9 N/mm

Peel strength II: 0.05 N/mm

Total judgement: AA

### EXAMPLE 5

The procedures of Example 1 were repeated except for employing the carrier-containing thin copper films A4 to give a roll of a polyimide-copper composite laminate having a width of approx. 530 mm.

The obtained polyimide-copper composite laminate had the following characteristics:

Appearance: AA

Peel strength I: 0.9 N/mm

Peel strength II: 0.04 N/mm

Total judgement: AA

### EXAMPLE 6

The procedures of Example 1 were repeated except for employing the three-layer polyimide film a2 and the carrier-containing thin copper films A3 to give a roll of a polyimide-copper composite laminate having a width of approx. 530 mm.

The obtained polyimide-copper composite laminate had the following characteristics:

Appearance: AA

Peel strength I: 0.8 N/mm

Peel strength II: 0.06 N/mm

Total judgement: AA

### EXAMPLE 7

The procedures of Example 1 were repeated except for employing the three-layer polyimide film b1 and the carrier-containing thin copper films B1 to give a roll of a polyimide-copper composite laminate having a width of approx. 530 mm.

The obtained polyimide-copper composite laminate had the following characteristics:

Appearance: AA

Peel strength I: 1.4 N/mm (before heat treatment}

Peel strength I: 1.4 N/mm (after heat treatment)

Peel strength II: 0.01 N/mm

Pin holes: Max.: 35/m², Min: 7/m², Ave.: 23/m²

Total judgement: AA

### EXAMPLE 8

The procedures of Example 1 were repeated except for employing the three-layer polyimide film b2 and the carrier-containing thin copper films B1 to give a roll of a polyimide-copper composite laminate having a width of approx. 530 mm.

The obtained polyimide-copper composite laminate had the following characteristics:

Appearance: AA

Peel strength I: 1.4 N/mm (before heat treatment}

Peel strength I: 1.4 N/mm (after heat treatment}

Peel strength II: 0.02 N/mm

Pin holes: Max.: 105/m², Min: 0/m², Ave.: 49/m²

Total judgement: AA

### EXAMPLE 9

The procedures of Example 1 were repeated except for employing the three-layer polyimide film b1 and the carrier-containing thin copper films B2 to give a roll of a polyimide-copper composite laminate having a width of approx. 530 mm.

The obtained polyimide-copper composite laminate had the following characteristics:

Appearance: AA

Peel strength I: 1.3 N/mm (before heat treatment}
1.3 N/mm (after heat treatment)

Peel strength II: 0.01 N/mm

Pin holes: Max.: 7/m², Min: 0/m², Ave.: 2/m²

Total judgement: AA

### EXAMPLE 10

The procedures of Example 1 were repeated except for employing the three-layer polyimide film b3 and the carrier-containing thin copper films B2 to give a roll of a polyimide-copper composite laminate having a width of approx. 530 mm.

The obtained polyimide-copper composite laminate had the following characteristics:

Appearance: AA

Peel strength I: 1.3 N/mm (before heat treatment}
1.2×/mm (after heat treatment)

Peel strength II: 0.02 N/mm

Pin holes: Max.: 525/m², Min: 98/m², Ave.: 306/m²

Total judgement: AA

### COMPARISON EXAMPLE 1

The procedures of Example 7 were repeated except for employing the three-layer polyimide film b1 and the carrier-containing thin copper films C1 to give a roll of a polyimide-copper composite laminate having a width of approx. 530 mm.

The obtained polyimide-copper composite laminate had the following characteristics:

Appearance: BB (apparent foaming)

Peel strength I: 1.0 N/mm

Peel strength II: 1.25 N/mm

Total judgement: BB

### COMPARISON EXAMPLE 2

The procedures of Comparison Example 1 were repeated except for employing heat treatment at 300° C. to give a roll of a polyimide-copper composite laminate having a width of approx. 530 mm.

The obtained polyimide-copper composite laminate had the following characteristics:

Appearance: BB

Peel strength I: 0.8 N/mm

Peel strength II: 0.25 N/mm

Total judgement: BB

[Evaluation of Polyimide-Copper Composite Laminate]

The polyimide-copper composite laminates obtained in Examples 7 and 8 had a weight of approx. 50 wt. % of a polyimide-copper composite laminate using a carrier film of 35 μm thick and a thickness of 70% of the polyimide-copper composite laminate using a carrier film of 35 μm thick. Accordingly, one roll could have 1,000 m of the continuous polyimide-copper composite laminate of each of Example 7 and 8, while one roll could have 500 m of the continuous polyimide-copper composite laminate using a carrier film of 35 μm thick.

When the carrier films were separated from the polyimide-copper composite laminates obtained in Examples 7 to 10 and the exposed copper films were etched using a dry film and an aqueous ferric chloride etching solution, a circuit board having a fine pattern circuit with 30 μm pitch was produced.

### COMPARISON EXAMPLE 3

The three-layer polyimide film c1 was plated with copper by conventional sputtering to give a copper-plated polyimide film (underlying metal: Ni—Cr, 3 nm, copper: 0.3 μm, plated copper layer: 3 μm). Using the copper-plated polyimide film, the same evaluation as in Example 9 was made. The results are set forth below:

Appearance: AA

Peel strength I: 1.3 N/mm (before heat treatment}
0.6 N/mm (after heat treatment)

Pin holes: Max.: 805/m², Min: 427/m², Ave.: 579/m²

Total judgement: BB

### COMPARISON EXAMPLE 4

The three-layer polyimide film c1 was plated with copper by conventional sputtering to give a copper-plated polyimide film (underlying metal: Ni—Cr, 3 nm, copper: 0.3 μm, plated copper layer: 1 μm). Using the copper-plated polyimide film, the same evaluation as in Example 9 was made. The results are set forth below:

Appearance: AA

Peel strength I: 1.3 N/mm (before heat treatment}
0.5 N/mm (after heat treatment)

Pinholes: Max.: 945/m², Min: 441/m², Ave.: 651/m²

Total judgement: BB

What is claimed is:

1. A polyimide-copper composite laminate comprising a metallic carrier having a thickness in the range of 10 to 35 μm and a thin copper film having a thickness in the range of 1 to 8 μm, and an intervening heat-resistant layer placed between the metallic carrier and the thin copper film and an aromatic polyimide film directly fixed to the thin copper film without adhesive.

2. The polyimide-copper composite laminate of claim 1, in which the intervening heat-resistant layer is made of ceramic material or metal.

3. The polyimide-copper composite laminate of claim 1, in which the aromatic polyimide film is fixed to the copper film at a peel strength of 0.7 N/mm or higher and the copper film is fixed to the metallic carrier at a peel strength of not higher than 0.2 N/mm.

4. The polyimide-copper composite laminate of claim 1, in which the metallic carrier has a thickness in the range of 10 to 22 μm.

5. The polyimide-copper composite laminate of claim 1, in which the metallic carrier has a thickness in the range of 15 to 22 μm.

6. The polyimide-copper composite laminate of claim 1, in which the copper film has a thickness in the range of 1 to 3 μm.

7. The polyimide-copper composite laminate of claim 1, in which the polyimide film is a multi-layer film comprising two thermoplastic aromatic polyimide layers and an intervening heat-resistant aromatic polyimide layer having no glass transition temperature below 300° C.

8. The polyimide-copper composite laminate of claim 7, which further comprises a metallic carrier having a thickness in the range of 10 to 35 μm and a thin copper film having 1 to 8 μm, and an intervening heat-resistant layer placed between the metallic carrier and the thin copper film, the thin copper film is fixed to a free side of the aromatic polyimide film.

9. The polyimide-copper composite laminate of claim 3, in which the peel strength between the aromatic polyimide film and the copper film shows no decrease after heat treatment at 150° C. for 168 hours.

10. The polyimide-copper composite laminate of claim 3, being subjected to 300° C. for 0.1 min. or longer in the heat treatment in the course of a laminating procedure and which shows no foaming.

11. A polyimide-copper composite laminate comprising a thin copper film having a thickness in the range of 1 to 8 μm and an aromatic polyimide film directly fixed to the thin copper film without adhesive, obtained by separating the carrier film from the polyimide-copper composite laminate of claim 1.

12. The polyimide-copper composite laminate of claim 11, being subjected to an etching procedure.

13. The polyimide-copper composite laminate of claim 11, which has pin-holes in numbers of at most 350/m².
